(19) United States
(12) Patent Application Publication
(10) Pub. No.: US 2019/0276137 A1
(43) Pub. Date: Sep. 12, 2019

(54) Closed Loop/Foil Propulsion System

(71) Applicant: Akpoviri Oteguono Enaohwo, Chicago, IL (US)

(72) Inventor: Akpoviri Oteguono Enaohwo, Chicago, IL (US)

(21) Appl. No.: 15/918,192

(22) Filed: Mar. 12, 2018

(51) Int. Cl. B64C 3/38; B64C 11/00; B64C 11/46

(52) U.S. Cl. CPC B64C 3/38; B64C 11/46; B64C 11/001

(57) ABSTRACT

A gas or liquid foil propulsion system is disclosed with internal wings or flaps which are positioned within a looped device. The ambient fluid (e.g. water of a body of water) or gas (e.g. air) flows through this loop and past at least one foil or air foil which is the wing or flap. This creates lift in the entire device. In some embodiments, the air foils are preceded by guide vanes which direct the flow of the ambient fluid or gas. In some embodiments, the loop is bifurcated creating two different paths of flow with the wings/flaps only in the outer sections of the bifurcation. In some embodiments, vents are used to allow inflow of the ambient medium. The device can be made of modular units which connect to each other to form, for example, a rectangular, circular, square or other shaped flow path.

### BACKGROUND OF THE DISCLOSED TECHNOLOGY

Aircraft function by creating lift from pressure regions created around the wings/rotor blades (in the case of rotary winged aircraft). The wings generally extend outward from the sides of the craft and are shaped such that air moves faster above the wing than below, causing lift. In the operation of rotary winged aircraft, blades revolve around an axis inducing airflow around said blades resulting in lift as with fixed wing aircraft described above. Such exterior wings take up a large amount of the width of the craft and often more than the width of the craft itself. It is desired to be able to decrease the width of the craft allowing for tighter maneuvering and movement into small spaces. Also desired is the elimination of exposed fast moving blades which result in significant safety, environmental and acoustic challenges.

Described below are improvements which would allow small craft to be produced, larger cabins relative to the wing space, greater efficiency, safer operation, improved acoustics and environmental interaction; amongst other advancements.

### SUMMARY OF THE DISCLOSED TECHNOLOGY

A closed loop air foil system of embodiments of the disclosed technology includes a housing. Within that housing are a plurality of guide vanes each adjacent to at least one flap. In some embodiments, adjacent to each guide vane are two flaps. Flaps are inclined at a predetermined and fixed angle in embodiments of the disclosed technology. The guide vanes are stationary (relative to the housing) devices with a plurality of portals directing air flow in a particular direction, such as in a direction parallel to housing which surrounds a respective guide vane. At least one motor (or other source of motive power) with a propeller/fan blade is arranged within the housing to push matter (a gas such as ambient air or a liquid such as ambient water) through at least one of the plurality of guide vanes first, followed by being pushed against the adjacent flap. The housing itself is sealed on at least two sides, three sides, or on all four sides.

The housing can further have a plurality of ventilation ports each opening into a same and/or opposite sides of the housing as each other, such as one on a top side and the other aligned opposite the former on a bottom side of the device. The ventilation ports can open (having openings aligned with or parallel to) the direction of gas/liquid flow. Further, each ventilation port and exterior housing can be mirrored on a top and bottom side. As such, the ventilation port or ports can be transverse to a most elongated length of the housing (the entirety of the housing a section of the housing on which the port is situated, a “section” being divided by a turn of 45 degrees or more in the housing).

The housing can be made up of identical or varying units, each with a single one of the guide vanes and one of the at least one flap. The identical or varying units are, in such an embodiment, joining together to form the closed loop. Separate corner pieces are used, in embodiments of the disclosed technology, to turn the air flow in another direction and close the loop, but the identical or varying units situated there-between have, in some embodiments, in order along an axis parallel to the most elongated length (of a section): an intake opening, a guide vane, a flap (or flaps), ventilation ports, and an exit port. An intake opening (portal where matter first enters while flowing there-through) and/or an exit port (portal where matter leaves the unit after flowing past a flap or set of flaps) is abutted against another identical or varying unit in some embodiments of the disclosed technology.

The housing bifurcates into a left and right path in some embodiments of the disclosed technology. When doing so, there can be at least one of the plurality of guide vanes in each left and right path. A center path, between and opening into the left and the right path, can have the at least one motor (or other source of motive power). The left and right paths can also have within the housing (other than matter being pushed there-through) only guide vanes and flaps adjacent to the guide vanes.

Described another way, a closed loop foil propulsion system has a continuous housing forming the closed loop, the housing having a top side, bottom side, left side, and right side substantially at 90 or 180 degree angles to one another. A propeller/fan blade directs matter (liquid, gas, or a combination thereof) in a first direction through the loop (e.g. clockwise or counter clockwise though the entirety of, a section of, or a modular part of the loop when looking from the top towards the loop, the top and bottom side having ventilation ports in embodiments of the disclosed technology). A plurality of guide vanes, each guide vane being adjacent to at least one flap are on a side of the flap upstream there-from. At least the left side and the right side, and in some embodiments, the bottom side are substantially sealed in embodiments of the disclosed technology. The top side and bottom side can also be substantially sealed in some embodiments or in other embodiments, include a plurality of openings opening substantially parallel to the direction of gas/liquid flow through the loop or the open path within the housing where matter passes through.

The plurality of openings in the top side and bottom side are positioned adjacent to a guide vane of the plurality of guide vanes in embodiments of the disclosed technology and directly above and below the flap of the at least one flap. The closed loop, in some embodiments, has a central region with a propeller/fan blade, the central region bifurcating into two side sections which have within them the plurality of guide vanes and every one of the flaps of the device. These side sections can join together at each end of the central region. Alternatively, in embodiments of the disclosed technology, the closed loop is in a rectangular shape. This rectangular shape is formed of modular pieces (defined as pieces which can readily attach and detach to other substantially identical pieces or pieces which can join together to form a loop and have a substantially identical size opening), each modular piece being either a corner piece or a piece with both a propeller/fan blade and a flap of the at least one flap.

Any device or step to a method described in this disclosure can comprise, or consist of, that which it is a part of, or the parts which make up the device or step. The term “and/or” is inclusive of the items which it joins linguistically, and each item by itself. Any object described can be as described or “substantially” as such wherein “substantially” is defined as “at least 95% true” or “at least 95% of the amount specified.”

### BRIEF DESCRIPTION OF THE DRAWINGS

FIG. 1 shows a perspective view of a modular foil device of embodiments of the disclosed technology.

FIG. 2 shows a top view of the modular foil device of FIG. 1.

FIG. 3 shows a side cutaway view of the foil device of FIG. 1.

FIG. 4 shows positioning of a guide vane and adjacent flaps within a modular foil of embodiments of the disclosed technology.

FIG. 5 shows the modular foil devices arranged into a rectangular shaped housing in an embodiment of the disclosed technology.

FIG. 6 shows the foil system arranged into a bifurcated path with a plurality of sets of vanes in the left and right sections thereof in an embodiment of the disclosed technology.

FIG. 7 shows a motor with parts which attach the motor to a housing of embodiments of the disclosed technology.

### DETAILED DESCRIPTION OF EMBODIMENTS OF THE DISCLOSED TECHNOLOGY

An air or water foil system is disclosed with internal wings or flaps which are positioned within a looped device. The ambient fluid (e.g. water of a body of water) or gas (e.g. air) flows through this loop and past at least one foil or air foil which is the wing or flap. This creates lift in the entire device. In some embodiments, the air foils are preceded by guide vanes which direct the flow of the ambient fluid or gas. In some embodiments, the loop is bifurcated creating two different paths of flow with the wings/flaps only in the outer sections of the bifurcation. In some embodiments, vents are used to allow inflow of the ambient medium. The device can be made of modular units which connect to each other to form, for example, a rectangular, circular, square or other shaped flow path.

Embodiments of the disclosed technology are described below, with reference to the figures provided.

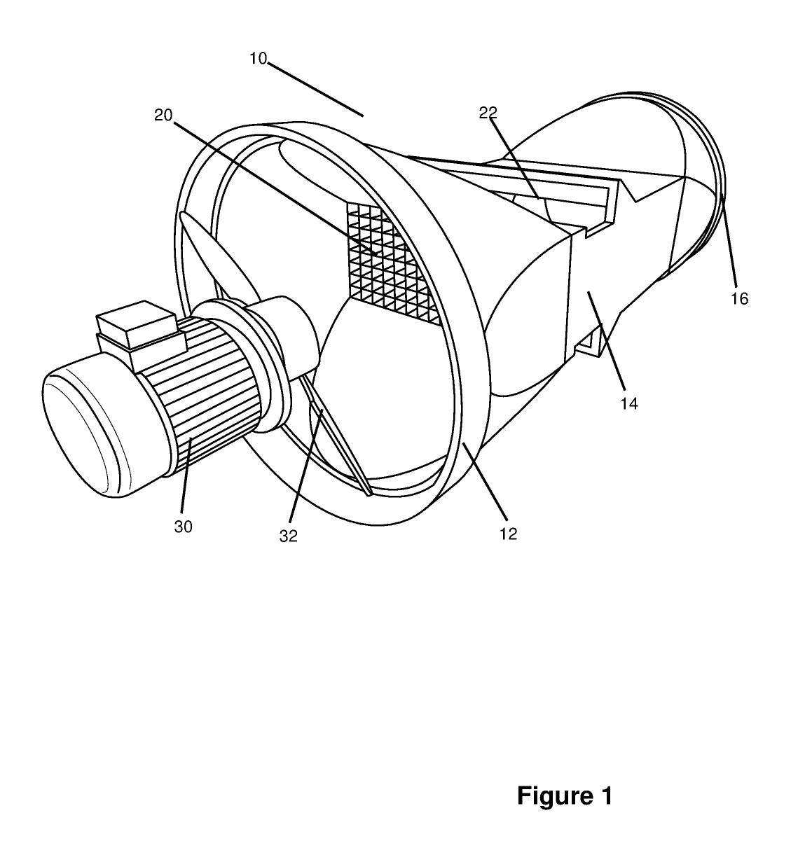

FIG. 1 shows a perspective view of a modular foil device of embodiments of the disclosed technology. The modular foil device 10 shown can be one of many which make up an entire enclosed housing where ambient medium (such as air or water or any gas, liquid, or combination thereof) passes through longitudinally. The “longitudinal” direction is the longest length of the device 10 between an intake opening 12 and exit portal 16. Matter (the ambient medium) passes in a direction from the intake opening 12 through the foil device 10 and out the exit portal 16 within a housing 14. The housing defines the exterior boundary of the foil device 10. Opening into the housing, such as on a top and/or opposite bottom side, is a vent 22 through which the ambient medium or matter can enter such as by way of suction as the matter within the housing 14 flows through. Such a vent 22 (an opening between the portals 12 and 16 at the extreme ends) is only on the top and in some embodiments, bottom side of the modular unit 10 in some embodiments. A “top side” is a side which is between the portals 12 and 16 and extends substantially perpendicular to the extreme end portals 12 and 16. A “bottom side” has the same definition as a “top side” except on an opposite side of the modular unit 10. The ventilation ports can be mirrored on the top and bottom sides of each unit such that there a horizontal line of symmetry through each unit.

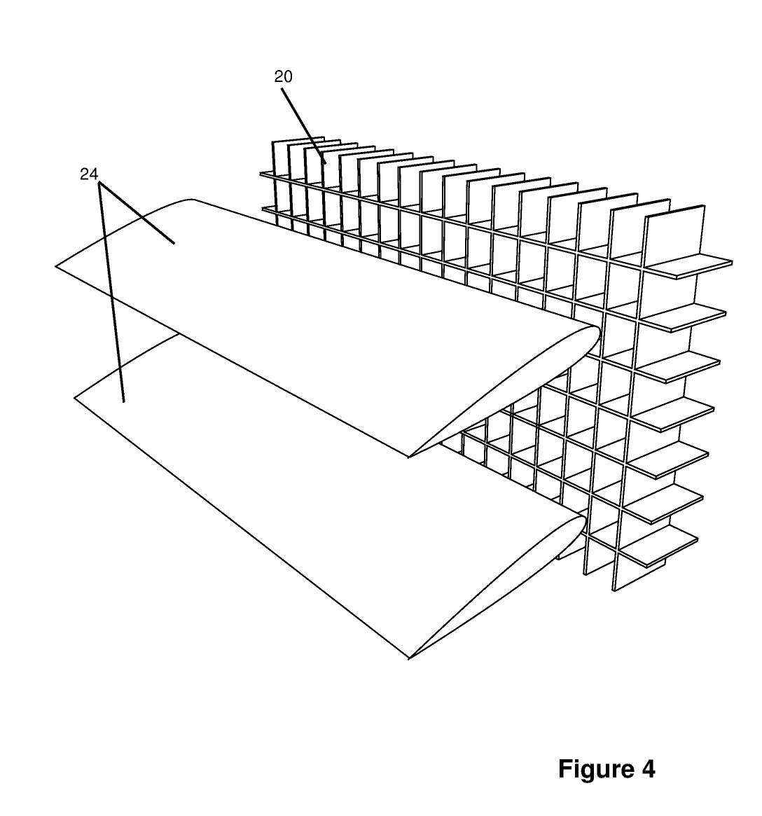

A motor (or other source of motive power which, for purposes of this disclosure, is included within the term “motor”) 30 with propeller/fan blade can be attached to a modular unit 10 and have the fan/propeller blades 32 within the housing 14 partially or fully. These blades, or an equivalent thereof, cause flow substantially or fully in the longitudinal direction of the housing 14 which is flow in a direction from intake opening 12 through the housing 14 and out of an exit portal 16. Guide vanes 20 are also seen in FIG. 1 which guide the flow of matter through the housing into paths which are parallel to the longitudinal axis of the modular unit 10 and/or housing 14. This will be discussed in more detail with respect to FIG. 4, below.

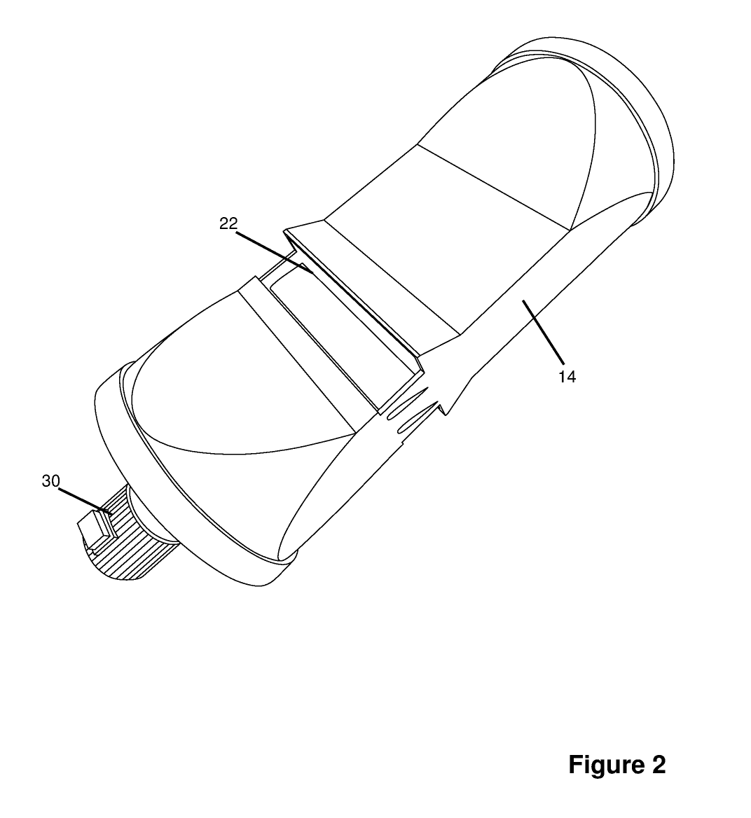

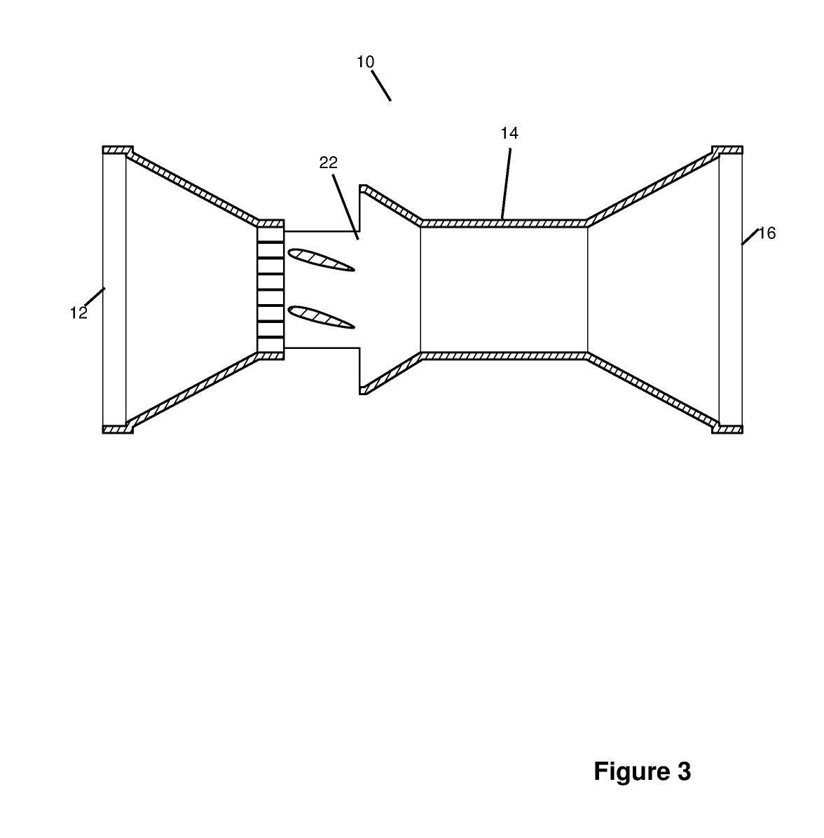

FIG. 2 shows a top view of the modular foil device of FIG. 1. FIG. 3 shows a side cutaway view of the foil device of FIG. 1. One can see the vent 22 in this view as well as the extreme edge of wings or flaps on the side of the device.

FIG. 4 shows positioning of a guide vane and adjacent flaps within a modular foil of embodiments of the disclosed technology. Adjacent to the guide vanes are wings or flaps 24. For purposes of this disclosure, “adjacent” is defined as “having no other fixed solid device there-between” and in some embodiments can also be “within 5 centimeters thereof”. The flaps 24 were not visible in the view shown in FIG. 1 because the guide vanes hid same from view. Thus, FIG. 4 is a view from the reverse side, compared to that of FIG. 1. Matter (liquid or gas) flows through the guide vanes 20 and past the wings/flaps 24 which create lift. The flaps 24 change the direction and pressure of the medium passing out the guide vanes and against/around the wings 24 creating the lift. The flaps 24 have a curved upper surface and a flatter lower surface in embodiments of the disclosed technology, making a cross-sectional shape known as an “airfoil” or simply a “foil.” As the ambient medium (again, air, water, or the like) moves past the wings/flaps 24 it is deflected such that the curved upper part of the wing lowers the pressure directly above it causing the wings/flaps 24 to move upwards in response to the flow through the housing 24. As the wings/flaps 24 are fixed to the housing 24, the entirety of the housing 24 moves upwards (in a direction such that the bottom of the device moves towards and/or past the previous position of the top of the device).

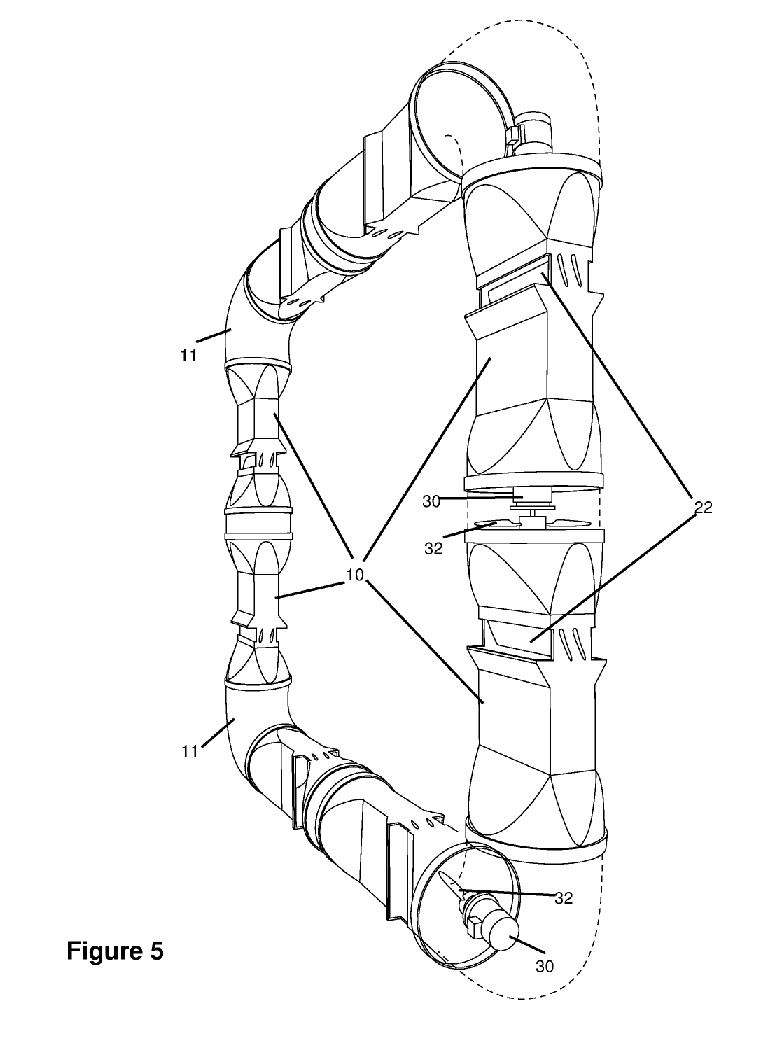

FIG. 5 shows the modular foil devices arranged into a rectangular shaped housing in an embodiment of the disclosed technology. Here, multiple modular units 10 are used to form the rectangle. The rectangle can be rounded. Two such units 10 are on each side and corner pieces 11 are used to turn the direction of flow 90 degrees at each corner and close the flow path. Thus, the flow of matter through the rectangle continues around in 360 degrees. One or more motors (or other source of motive power) 30 with propellers/fan blades 32 are used, such as one on each side of the rectangle or one at each modular unit 10. The intake end 12 of one modular unit 10 can be adjacent to an exit portal 16 of the next modular unit 10. The vents 22 are on the top side and/or bottom side of each modular unit 10, specifically the top side and/or bottom side of the rectangular shaped section of each modular unit 10 in some embodiments. The actual opening of each vent 22 can be in parallel with the intake opening of each unit (perpendicular to the most elongated length of each modular unit).

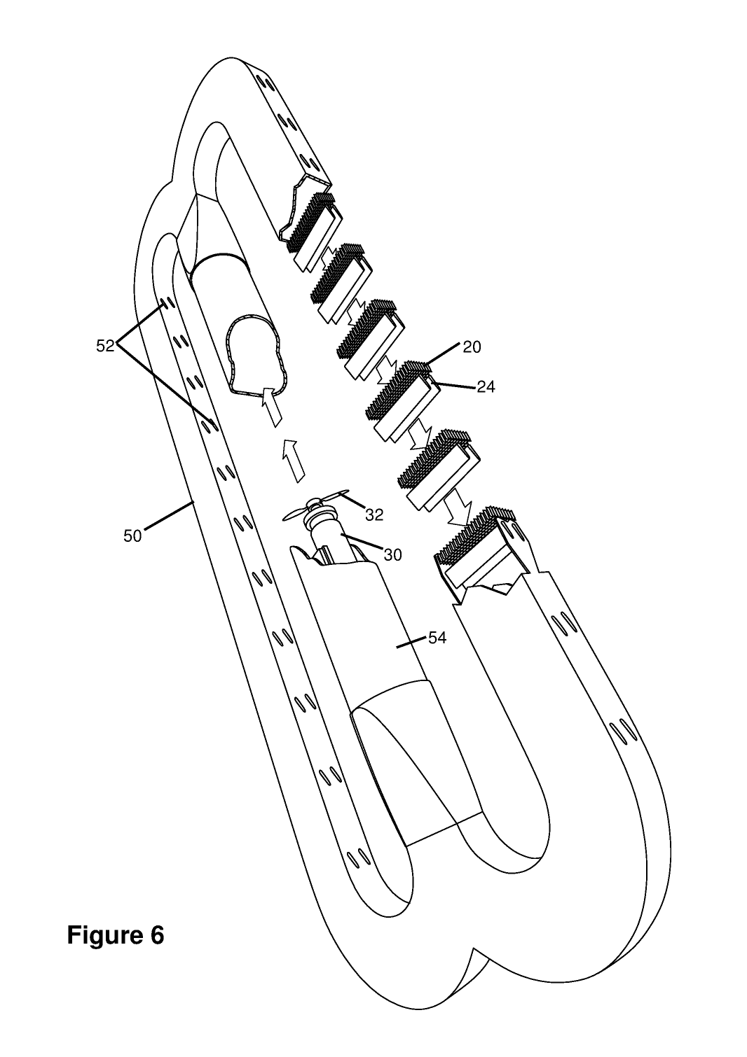

FIG. 6 shows the foil system arranged into a bifurcated path with a plurality of sets of vanes in the left and right sections thereof in an embodiment of the disclosed technology. Here a central section or region 54 bifurcates into two side regions 50. One or more guide vanes 20 and associated wings/flaps 24 adjacent thereto are in the sides of side regions 50 of the device. The motor or motors 30 in this embodiment are in the central region 54, as shown and there is a closed path of flow of matter/ambient medium in one direction in the central region 54 and in the opposite direction throughout the majority of the side paths 50, flowing in two looped paths in the direction shown by the arrows. The label 52 points towards either the position of the side edge of each flap/wing 24 and/or portals through which ambient medium flows.

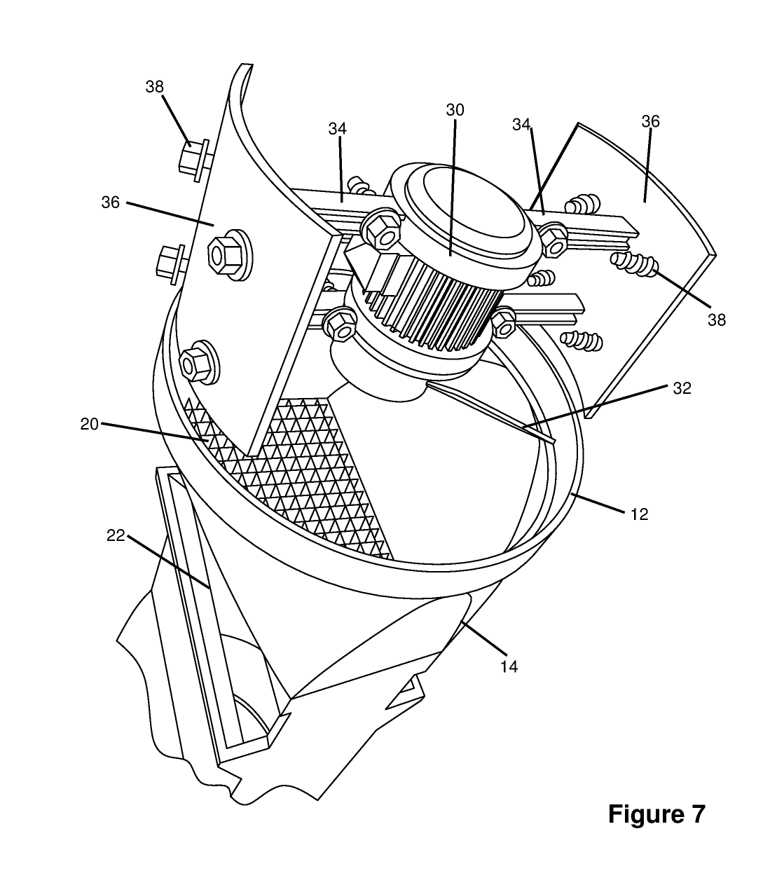

FIG. 7 shows a motor with parts which attach the motor to a housing of embodiments of the disclosed technology. Here, the motor 30 has a spindle attached to the propeller/fan blades 32 and is housed within a housing mounted to poles 34 that terminate in rounded plates 36. The rounded plates 36 have an exterior circumference/shape which is substantially or fully equal to the interior circumference/shape of a housing where the motor is mounted such as housing 14 and/or the intake opening 12. Screws 38 or other fasteners are used to fix the rounded plates 36 to the housing 14 in embodiments of the disclosed technology. As such, the motor 30 and blades 32 can be positioned central to the intake portal (centered within the portal 12 or housing 14).

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A closed loop gas or liquid foil propulsion system comprising:
a housing surrounding:
a plurality of guide vanes each adjacent to at least one flap;
at least one motor with a propeller arranged to push matter through at least one of said plurality of guide vanes before said matter is pushed against said adjacent at least one said flap;
wherein said housing is sealed on at least two sides.

2. The closed loop foil propulsion system of claim 1, wherein said housing further comprises:
a plurality of ventilation ports each opening into one of a same or opposite sides of said housing as each other ventilation port of said plurality of ventilation ports.

3. The closed loop foil propulsion system of claim 2, wherein an opening of each said ventilation port is transverse to a most elongated length of said housing.

4. The closed loop foil propulsion system of claim 3, wherein said housing is comprised of identical units each with a single one of said guide vanes and one of said at least one flap, said identical units joining together to form said closed loop.

5. The closed loop foil propulsion system of claim 4, wherein at least one of said identical units comprises, in order along an axis parallel to said most elongated length:
an intake opening;
a guide vane of said plurality of guide vanes;
said at least one said flap;
a ventilation port of said plurality of ventilation ports;
an exit port;

6. The closed loop foil propulsion system of claim 5, wherein at least one of said intake opening or said exit port is abutted against another identical unit of said identical units.

7. The closed loop foil propulsion system of claim 1, wherein said housing bifurcates into a left and right path, each said left and said right path comprising at least one of said plurality of guide vanes and a center path, between and opening into said left and said right path, comprising said at least one motor.

8. The closed loop foil propulsion system of claim 7, wherein said left and said right path of said housing comprises there-within only said plurality of guide vanes with said adjacent said at least one flap.

9. A closed loop foil propulsion system comprising:
a continuous housing forming said closed loop, said housing having a top side, bottom side, left side, and right side substantially at 90 or 180 degree angles to one another;
a propeller or fan blade directing matter in a first direction through said loop;
wherein at least said left side and said right side are substantially sealed.

10. The closed loop foil propulsion system of claim 9, wherein said top side and said bottom side are substantially sealed.

11. The closed loop foil propulsion system of claim 9, wherein said top and bottom sides includes a plurality of openings opening substantially parallel to said first direction.

12. The closed loop foil propulsion system of claim 11, wherein each opening of said plurality of openings in said top and bottom sides are positioned adjacent to a guide vane of a plurality of guide vanes and directly above or below said at least one flap.

13. The closed loop foil propulsion system of claim 9, wherein said closed loop has a central region with said propeller or said fan blade which bifurcates into two side sections with a plurality of guide vanes and every said at least one flap.

14. The closed loop foil propulsion system of claim 13, wherein said two side sections join together at each end thereof with said central region.

15. The closed loop foil propulsion system of claim 9, wherein said closed loop is in a rectangular shape.

16. The closed loop foil propulsion system of claim 15, wherein said rectangular shape is made of modular pieces, each modular piece being either a corner piece or a piece with both a propeller and a flap of said at least one flap.
